(19) United States
(12) Patent Application Publication
(10) Pub. No.: US 2004/0167705 A1
(43) Pub. Date: Aug. 26, 2004

(54) Method For Estimating The Mass Of A Vehicle Which Is Being Driven On A Road With A Varying Gradient And Method For Estimating The Gradient Of The Road Upon Which The Vehicle Is Being Driven

(75) Inventors: Peter LINGMAN, Goteborg (SE); Bengt SCHMIDTBAUER, Kungalv (SE)

Correspondence Address: TRACY W. DRUCE, ESQ., 1496 EVANS FARM DR, MCLEAN, VA, 22101, US

(73) Assignee: VOLVO LASTVAGNAR AB, Goteborg (SE)

(21) Appl. No.: 10/708,213

(22) Filed: Feb. 17, 2004

Related U.S. Application Data
(63) Continuation of application No. PCT/SE02/01476, filed on Aug. 19, 2002.

(30) Foreign Application Priority Data
Aug. 17, 2001 (SE) 0102776-2

(51) Int. Cl. G06F 7/00

(52) U.S. Cl. 701/124; 180/273

(57) ABSTRACT

Method for estimating the mass of a vehicle which is being driven on a road with varying gradient, comprising the following method steps: measurement of the vehicle's speed for generating input data for a calculation device; measurement of a variable which comprises a longitudinal force acting on the vehicle for generating input data for a calculation device, and method for estimating the gradient of a road on which a vehicle is being driven, comprising the following method steps: measurement of the vehicle's speed for generating input data for a calculation device; measurement of a variable which comprises a longitudinal force acting on the vehicle for generating input data for a calculation device.

### CROSS REFERENCE TO RELATED APPLICATIONS

The present application is a continuation patent application of International Application No. PCT/SE02/01476 filed 19 Aug. 2002 which was published in English pursuant to Article 21(2) of the Patent Cooperation Treaty, and which claims priority to Swedish Application No. 0102776-2 filed 17 Aug. 2001. Both applications are expressly incorporated herein by reference in their entireties.

### BACKGROUND OF INVENTION

1. Technical Field

The invention relates to a method for estimating the mass of a vehicle which is being driven on a road with a varying gradient according to the preamble to claim 1. The invention also relates to a method for estimating the gradient of the road on which the vehicle is being driven according to the preamble to claim 13. In particular, it relates to a method for simultaneously estimating the mass and the gradient of the road on which the vehicle is being driven.

2. Background Art

In order to ensure that a vehicle's movement patterns can be controlled in a satisfactory way, reliable information for controlling the vehicle's transmission line and braking system must be available. It is of the greatest importance that reliable information is available regarding the vehicle's mass, its speed and the gradient of the road.

A normally used method for simultaneously estimating a vehicle's mass and the gradient of the road on which the vehicle is being driven is to calculate the vehicle's acceleration at two adjacent moments in time, which are typically within an interval of 0.5 seconds. By this means gravitational forces, roll resistance and air resistance can be assumed to be constant. By utilizing Newton's second law, at said two measurement points, the vehicle's mass, which is the only unknown parameter in the equation once the acceleration has been calculated, is calculated from measured data concerning the speed at said two measurement points. The measurement signal concerning the vehicle's speed is normally noisy. In order to obtain a relatively good estimate of the vehicle's acceleration from the noisy speed signal, it is important that the difference in speed should be relatively large in spite of the short interval between the measurement points. One way of obtaining this is to move one measurement point to a time immediately before changing gear and the second time to immediately after changing gear. However, there are a number of problems associated with this method. Firstly, this method requires the measurement to be carried out during difficult conditions as oscillations arise in the transmission line due to the flexibility of the transmission line and, where applicable, the play in the coupling between the tractor unit and trailer. The oscillations are stimulated by the driving force being discontinuous during the gear changing procedure. In addition, this method cannot be used if the vehicle is equipped with a gearbox of the so-called “power-shift” type where the power from the engine is not disconnected during a gear change.

Another type of commonly occurring gear box is an automatically-controlled manual gear box, where the actual gear change procedure is controlled by an actuator after the gear position has been selected by the driver. In these gearboxes, the gear position is detected by a sensor after which a control signal to the actuator effects the gear change. With this type of gear box, it is possible to carry out the gear change procedure with good control. A problem with changing gear, particularly while traveling up an incline, is that the vehicle loses speed during the gear change procedure as there is an interruption in the transmitted torque. This means that it is desirable to keep the gear change procedure as short as possible. Manufacturers of gearboxes therefore try to minimize the time for the gear change procedure with automatically-controlled manual gearboxes, which means that the time for carrying out an estimation is reduced, whereby the accuracy of the measurement is reduced.

An example of a method which in reality requires the measurement to be carried out during the moment of changing gear is U.S. Pat. No. 5,549,364. The reason for this is that no simultaneous estimation of the mass and the gradient of the road is carried out. This means that the estimating method is dependent upon two time-discrete measurement occasions. In order to manage the very noisy speed signal, the measurement thus needs to be carried out during the gear change procedure, with the abovementioned problems as a result.

U.S. Pat. No. 6,167,357 describes an example of a recursive method for estimating the mass of a vehicle. According to the method described, there is a simultaneous determination of the vehicle's mass and an air resistance coefficient. This coefficient is, however, not a variable, but a constant, for which reason the method described cannot be used for the determination of the gradient of the road.

### SUMMARY OF INVENTION

The object of the invention is to provide a method for estimating the mass of a vehicle and/or the gradient of the road, which method does not require measurements to be carried out specifically during a gear change procedure.

This object is achieved by a method for estimating the mass of a vehicle according to the characterizing part of claim 1. By using a calculating device within which a recursive process generates an estimate of the weight of the vehicle by utilizing a statistical filter utilizing input data comprising the vehicle's speed and a parameter which comprises a horizontal force acting on the vehicle, the mass of the vehicle can be determined with good convergence utilizing a statistical representation of a road with varying gradient.

This object is also achieved by a method for estimating the gradient of the road on which a vehicle is being driven, according to the characterizing part of claim 13. By utilizing a calculating device within which a recursive process generates an estimate of the gradient of the road on which a vehicle is being driven by the utilization of a statistical filter utilizing said input data comprising the vehicle's speed and a parameter which comprises a horizontal force acting on the vehicle, the road's gradient can be determined with good convergence utilizing a statistical representation of a road with varying gradient.

In a particularly preferred embodiment of the invention, the gradient of the road on which the vehicle is being driven and the mass of the vehicle are determined simultaneously.

In a preferred embodiment of the invention, a Kalman filter or an extended Kalman filter is used as statistical filter in a recursive process constituting an estimating method for the vehicle's mass and/or gradient of the road on which the vehicle is being driven. The vehicle's equation of motion constitutes in all cases the base equation for the Kalman filter.

A Kalman filter is an estimating method for linear systems which takes account of the statistical behavior of a process and measurement interference. In general, a Kalman filter is described by the system:

\dot{x}=Ax+Bu+v:y=Cx+Dy+w

where x is a state vector, y is a measurement vector, u is a known system effect and v and w are interference vectors for process and measurement.

An extended Kalman Filter is an estimating method for non-linear systems.

A fuller description of Kalman filters is given, for example, in Schmitbauer B. “Modellbaserade reglersystem”, studentlitteratur 1999.

By means of the method according to the invention, a simultaneous estimation is obtained of the vehicle's mass and the gradient of the road on which the vehicle is being driven.

In a preferred embodiment, the statistical representation of the gradient of the road consists of a first order process with an intensity d and a switching frequency ω_{c}. An estimate from a frequency range from a reference road can be used as the initial values of the intensity d and switching frequency ω_{c}. According to an embodiment of the invention, it is however possible to update the value of the parameters d and ω_{c} by studying the variation in the value of the gradient of the road calculated by the process and inserting the most suitable value for the occasion. One way is to store the gradient estimate in a batch and then (perhaps every two hours) run a typical RLS (Recursive Least Square) algorithm in order to set the parameters, that is a first order process is adapted to a measurement series. A fuller description of how updating can be achieved is given in Lennart Ljung, System identification—theory for the user.

According to an embodiment of the invention, the longitudinal force component is estimated from an estimate of torque delivered by an internal combustion engine fitted in the vehicle. The estimation is carried out in a way that is well known to a person skilled in the art from input data comprising provided fuel quantity, current engine speed and the speed of the vehicle. An example of how calculation of propulsion torque from vehicle data is carried out is given in U.S. Pat. No. 6,035,252. In an alternative embodiment of the invention, the longitudinal force component is estimated by utilization of an accelerometer which measures the acceleration in the longitudinal direction. According to a third embodiment of the invention, the longitudinal force component is estimated by a torque sensor located in the vehicle's transmission line.

According to a preferred embodiment of the invention, the method is used for estimating the mass of the vehicle for dividing braking force between brakes in the vehicle's tractor unit and trailer.

### BRIEF DESCRIPTION OF DRAWINGS

The invention will be described below in greater detail with reference to the attached drawings, in which:

FIG. 1 shows schematically a vehicle comprising a control circuit for carrying out a method for estimating the vehicle's mass and/or the gradient of the road according to the invention,

FIG. 2 shows a block diagram for executing a method for estimating the vehicle's mass and/or the gradient of the road according to the invention,

FIG. 3 shows the result from simulations of estimations of the mass and the gradient of the road by the use of the estimation method according to the invention, and

FIG. 4 shows schematically a method for estimating the vehicle's mass and/or the gradient of the road.

### DETAILED DESCRIPTION

In a first model, the gradient of the road is estimated for a vehicle of known mass. The model is based on the vehicle's equation of motion in the vehicle's longitudinal direction. By the vehicle's longitudinal direction is meant the direction along the vehicle's route irrespective of at what angle in relation to the horizontal plane the vehicle is currently being driven.

The equation of motion has the form:

m\dot{v}=mg sin α+fₚ−fᵣ

where α is the gradient of the road, fₚ the propulsion force and fᵣ the retardation force. The propulsion force fₚ comprises positive propulsion torque from an engine in the vehicle filtered via the vehicle's transmission. The retardation force fᵣ comprises retarding forces from wheels, auxiliary brakes and deterministic components of roll resistance and air resistance.

Both applied propulsion force fₚ and retardation forces fᵣ are regarded as known input signals to the statistical filter.

We have thus an input signal of the form:

u(t)=fₚ(t)−fᵣ(t)=f(t)

After selection of the vehicle's speed v and the gradient of the road as state variables, the following state equations are obtained:

$$\begin{matrix}{x}_{1} = v ⇒ {\dot{x}}_{1} = {gx}_{2} + \frac{1}{m} f ( t ) + {υ}_{1} \\ {x}_{2} = α ⇒ {\dot{x}}_{2} = \dot{α} = {υ}_{2} \\ y = {x}_{1} + w\end{matrix}$$

In this model, a statistical representation of a road with varying gradient is introduced. In an analysis, the frequency range of a reference road has been measured. Study of the frequency range shows that the frequency range can be approximated with relatively good accuracy by a first order process. Of course, other processes of higher order can be used, with the result that the dimensions of the state equations increase. The studied reference road segment shows a switching frequency of f_{c}=0.002 cycles/m and a noise intensity of 0.8 (radians)²/(cycles/m)

The statistical representation is used in the above state equation, whereby the following state equation is obtained:

$$\begin{matrix}{x}_{1} = v ⇒ {\dot{x}}_{1} = {gx}_{2} + \frac{1}{m} f ( t ) + {υ}_{1} \\ {x}_{2} = α ⇒ {\dot{x}}_{2} = \dot{α} = - {ω}_{c} {x}_{2} + {υ}_{2}\end{matrix} \} ⇒ A = [ \begin{matrix}0 & g \\ 0 & - {ω}_{c}\end{matrix} ] υ = [ \begin{matrix}{υ}_{1} \\ {υ}_{2}\end{matrix} ]$$

A further possibility for improving the estimate of the gradient of the road is obtained by an improved model of the interference forces, where the interference forces are modeled by a first order process instead of being modeled by white noise.

This is possible, as the magnitude of the error in the propulsion and braking torque from the engine and auxiliary brakes, roll resistance and air resistance is known, but not its frequency content. The state equation is therefore extended by an additional state x₃=f_{dist} and thereafter has the following appearance:

$$A = [ \begin{matrix}0 & g & 1 / m \\ 0 & - {ω}_{c} & 0 \\ 0 & 0 & - {ω}_{d}\end{matrix} ] \qquad Bu = [ \begin{matrix}f ( t ) / m \\ 0 \\ 0\end{matrix} ] \qquad v = [ \begin{matrix}0 \\ {v}_{2} \\ {v}_{3}\end{matrix} ]$$

where ω_{d} is the switching frequency of the interference force and d is the intensity of the noise.

In order to make possible simultaneous estimation of the mass of the vehicle and the gradient of the road on which the vehicle is being driven, the state equation must be extended by at least one additional state corresponding to the mass of the vehicle. According to this embodiment of the invention, the mass of the vehicle and the gradient of the road on which the vehicle is being driven are estimated by using an estimation of a variable which comprises longitudinal force components which in this case correspond to applied propulsion force fₚ and retardation forces fᵣ together with a statistical representation of a road with varying gradient. The propulsion force is estimated according to an embodiment of the invention by input data concerning the speed of the vehicle, amount of fuel supplied to the vehicle's cylinders and current engine speed of the internal combustion engine being transformed into a value for propulsion torque of the internal combustion engine. This transformation between input data and propulsion torque is carried out in a processor in the vehicle in a way that is well known to a person skilled in the art by the utilization of calculations and mappings of input data into propulsion torque based on experience. According to an alternative embodiment of the invention, the propulsion torque is estimated by an output signal from a torque sensor placed in the vehicle's transmission line. The estimated torque is thereafter transformed by filter to a propulsion force via information concerning current gearing between the drive shaft from the internal combustion engine and the driving wheels.

Together with the utilization of a first order model of the variation in the gradient of the road, according to what was described above, we obtain the following state equation:

$$\dot{v} = g α + \frac{f ( t )}{m} + \frac{{f}_{dist}}{m}$$

$$\dot{v} = {\dot{x}}_{1} = {gx}_{2} + \frac{f ( t )}{{x}_{3}} + \frac{{x }_{4}}{{x}_{3}}$$

$$\dot{α} = {\dot{x}}_{2} = - {ω}_{c} {x}_{2} + {υ}_{2}$$

$$\dot{m} = {\dot{x}}_{3} = {υ}_{3}$$

$${\dot{f}}_{dist} = {\dot{x}}_{4} = - {ω}_{d} {x}_{4} + {υ}_{4}$$

The equation is a non-linear state equation, for which reason an extended Kalman filter must be used. The state equation is of the form

\dot{x}=f(x,t)+v

y=g(x,t)+w

where f(x,t) is non-linear and g(x,t) is linear. By the use of an extended Kalman filter, the model is linearized around the estimate of the state vector x. Difference equations are preferably used instead of differential equations in real-time applications. Together with a Euler approximation of the time derivative, x=(x(t+h)−x(t))/h, this gives a discrete state equation as follows:

$$\begin{matrix}{x}_{1} ( t + 1 ) = {x}_{1} + h g {x}_{2} + \frac{h f ( t )}{{x}_{3}} + \frac{h {x}_{4}}{{x}_{3}} = {f}_{1} \\ {x}_{2} ( t + 1 ) = ( 1 - h {ω}_{c} ) {x}_{2} + h {v}_{2} = {f}_{2} + h {v}_{2} \\ {x}_{3} ( t + 1 ) = {x}_{3} + h {v}_{3} = {f}_{3} + h {v}_{3} \\ {x}_{4} ( t + 1 ) = ( 1 - h {ω}_{d} ) {x}_{4} + h {v}_{4} = {f}_{4} + h {v}_{4}\end{matrix}$$

The next step is to linearize the above state equation around the estimate of the state vector x, whereby the following linear state equation is obtained:

$$\begin{matrix}[ \begin{matrix}δ {x}_{{1}_{t + 1}} \\ δ {x}_{{2}_{t + 1}} \\ δ {x}_{{3}_{t + 1}} \\ δ {x}_{{4}_{t + 1}}\end{matrix} ] = [ \begin{matrix}1 & hg & - \frac{h ( f ( t ) - {\hat{x}}_{4} )}{{\hat{x}}_{3}^{2}} & \frac{h}{{\hat{x}}_{3}} \\ 0 & 1 - {hd}_{2 α} & 0 & 0 \\ 0 & 0 & 1 & 0 \\ 0 & 0 & 0 & 1 - {hd}_{2}\end{matrix} ] [ \begin{matrix}δ {x}_{{1}_{t}} \\ δ {x}_{2 t} \\ δ {x}_{{3}_{t}} \\ δ {x}_{{4}_{t}}\end{matrix} ] + \\ [ \begin{matrix}0 \\ h {υ}_{2} {d}_{1 α} \\ h {υ}_{3} \\ h {υ}_{4} {d}_{1}\end{matrix} ] , \\ [ y ] = [ C ] [ \begin{matrix}δ {x}_{{1}_{t}} \\ δ {x}_{{2}_{t}} \\ δ {x}_{{3}_{t}} \\ δ {x}_{4 t}\end{matrix} ] + [ w ]\end{matrix}$$

Simultaneous estimation of the mass m of the vehicle and the gradient α of the road on which the vehicle is being driven is now possible by using the above state equation recursively utilizing the vehicle's speed v and information about applied propulsion force fₚ and retardation forces fᵣ. The propulsion force fₚ consists of positive propulsion torque from an engine in the vehicle filtered via the vehicle's transmission. The retardation forces fᵣ comprise retarding forces from wheels, auxiliary brakes and deterministic components of roll resistance and air resistance. In order to obtain a stable approximation of the state vector, in a preferred embodiment the process is stopped when the driver applies the service brake as the friction between the brake lining and the brake disc normally has great stochastic variation.

According to a second embodiment of the invention, the mass of the vehicle and the gradient of the road on which the vehicle is being driven are estimated by using an estimation of a variable which comprises a longitudinal force component which in this case corresponds to an input signal from an accelerometer that measures specific force along the vehicle's longitudinal extent together with a statistical representation of a road with varying gradient.

In this case, a state variable x₃ is introduced, which corresponds to the longitudinal acceleration in the state equation. The longitudinal acceleration is modeled with a first order process with a switching frequency ω_{d}. We obtain a state equation as follows:

$$\begin{matrix}{x}_{1} = v ⇒ {\dot{x}}_{1} = {gx}_{2} - a ( t ) + {x}_{3} \\ {x}_{2} = α ⇒ {\dot{x}}_{2} = - {x}_{2} {ω}_{c} + {υ}_{2} \\ {x}_{3} = {a}_{d} ⇒ {\dot{x}}_{3} = - {x}_{3} {ω}_{d} + {υ}_{3}\end{matrix} \} ⇒ A = [ \begin{matrix}0 & g & 1 \\ 0 & - {ω}_{c} & 0 \\ 0 & 0 & - {ω}_{d}\end{matrix} ]$$

$$υ = [ \begin{matrix}0 \\ {υ}_{2} \\ {υ}_{3}\end{matrix} ] Bu = [ \begin{matrix}- a ( t ) \\ 0 \\ 0\end{matrix} ] C = {[ \begin{matrix}1 \\ 0 \\ 0\end{matrix} ]}^{T} \begin{matrix} \\ \end{matrix}$$

By using the input signal a(t) from an accelerometer, the estimation of the gradient of the road on which the vehicle is being driven can be carried out without direct connection to the mass of the vehicle. The vehicle's mass can therefore be estimated simultaneously by utilizing the control force f(t) according to the above, by the relationship a(t)=This means that when the input signal from an accelerometer is used, the estimation problem can be divided between two separate filters, a kinematic filter without equation of motion for estimating the gradient of the road and a dynamic filter concerning the mass.

The dynamic filter's appearance for determining the mass is apparent from the following state equation:

$$\begin{matrix}{x}_{1} = m ⇒ {\dot{x}}_{1} = {υ}_{1} \\ y = f ( t ) = ( a ( t ) - {\hat{x}}_{3} ) {x}_{1} + w\end{matrix} \} ⇒ A = 0$$

$$Bu = [ 0 ] C = [ ( a ( t ) - {\hat{x}}_{3} ) ] υ = [ {υ}_{1} ]$$

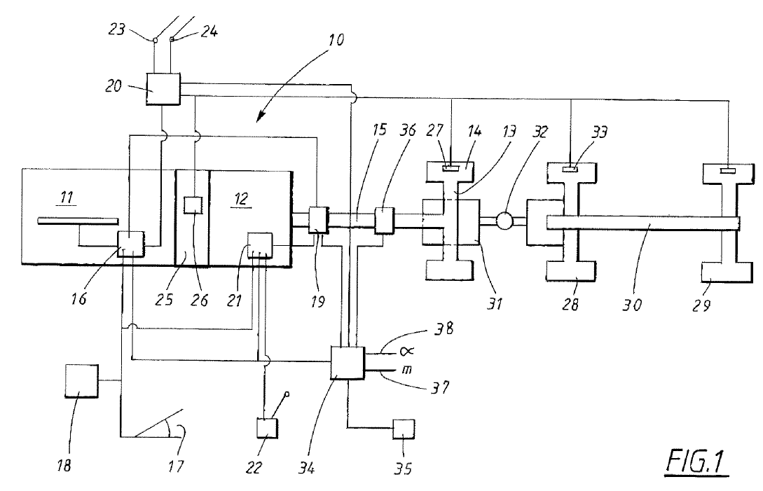

FIG. 1 shows schematically a control system for a vehicle where the method described above can be applied for estimating the gradient of the road on which the vehicle is being driven, the mass of the vehicle, or alternatively simultaneous estimation of the gradient of the road on which the vehicle is being driven and the mass of the vehicle.

The control system is of the type that is described in patent specification U.S. Pat. No. 6,167,357 to which reference should be made for a more detailed description.

The vehicle 10 comprises an internal combustion engine 11 and a gearbox 12 which connects the internal combustion engine 11 to a drive shaft 13 for a set of wheels 14 via an outgoing shaft 15. The internal combustion engine 11 is controlled by an engine control unit 16 which uses an input signal from an accelerator pedal 17 and where applicable a constant speed regulator 18. The internal combustion engine 11 and its engine control unit 16 are of conventional type where the engine control unit controls the fuel injection, engine brake, etc, according to input signals from the accelerator pedal 17, speed sensor and brake control system 20.

The gearbox 12 is controlled according to the embodiment shown by a gearbox control unit 21 which controls the gear shift by the input signal from the speed sensor 19 or alternatively from the input signal from a gear selector 22 on the vehicle. The invention can also be used on vehicles without electronically-controlled gearboxes. In an embodiment of the invention, it is, however, necessary to record which gear is currently being used by the vehicle. The gearbox and its control unit are of conventional type.

The brake control system 20 is controlled by input signals from a service brake control 23 and, where applicable, an auxiliary brake control 24. The apportionment between service brake and auxiliary brake can, where applicable, be carried out automatically. The brake control system generates output signals to the engine control system 16 for controlling the injection and the engine brake, to other auxiliary brakes, where applicable, for example in the form of a retarder 25 which is controlled by a control device 26, and to the service brakes 27. Where applicable, there is a apportionment of the braking force between the vehicle's pairs of wheels and, where applicable, service brakes 33 on pairs of wheels 28, 29 on a trailer unit 30 connected to the framework structure 31 of the vehicle 10 via a coupling 32.

The vehicle also comprises a calculating device 34 for estimating the mass of a vehicle, for estimating the gradient of the road on which the vehicle is being driven, or alternatively for simultaneously estimating the mass of a vehicle and estimating the gradient of the road on which the vehicle is being driven.

The calculating device 34 receives input data from the speed sensor 19. According to an embodiment of the invention, the calculating device receives in addition information from an accelerometer 35 which measures the vehicle's acceleration in the longitudinal direction and uses this information to determine a variable which comprises a longitudinal force acting on the vehicle. According to an alternative embodiment, a variable is measured which comprises a longitudinal force acting on the vehicle by recording applied propulsion force fₚ and retardation forces fᵣ. For this purpose, the calculating device uses input signals from the brake control system 20 for determining the size of the applied braking forces, in particular the size of forces applied via the auxiliary brakes. In addition, input signals are used from the speed sensor 19 to determine the roll resistance and air resistance. In an embodiment of the invention, information from the engine control system 16 is used for determining torque delivered by the internal combustion engine. In another embodiment of the invention, the input signal from a torque sensor 36 placed along the vehicle's transmission line is used. In addition, the input signal from the gearbox control unit 21 is used to determine the applied propulsion force from the calculated or measured propulsion torque.

All the input signals to the calculating device 34 are of conventional type and are available via the communication system that is used in the vehicle, normally a data bus.

The calculating device 34 generates output signals corresponding to the gradient of the road on which the vehicle is being driven 38 and/or the vehicle's mass 37, depending upon which of the processes described above for determining the state equations determining the vehicle's movement has been selected. The calculating device 34 comprises memory areas and processors whereby iteration of the recursive process can be carried out with generation of an estimate of the gradient and/or the mass as a result.

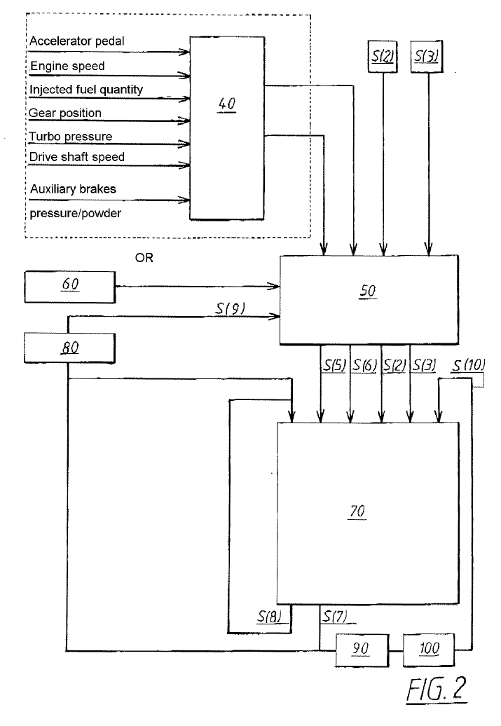

FIG. 2 shows a block diagram for a process for executing a method for estimating the vehicle's mass according to the invention.

The figure describes the principal flow for simultaneous estimation of mass and gradient (without specific force measurement). The estimation/measurement of the tractive force and auxiliary braking force are not dealt with in detail. Nor is the signal processing (filtering, etc) of other measured signals dealt with in detail.

The following designations are used for quantities in the estimation process.

Area: The wind resistance area of the vehicle

Cd: Wind resistance coefficient

Cr: Roll resistance coefficient

g: Gravitation constant

h₁: Updating time for f_threshold

h₂: Updating of the gradient process parameters, relatively long time (hours)

h: Sampling time

d: The intensity of the gradient process

e: The intensity of the force interference process

In a first function block 40, the applied propulsion torque is estimated and also the calculated propulsion force from the estimate of the propulsion torque. In addition, the applied braking torque and braking force from auxiliary brakes are estimated. Input data to the first function block 40 consists of a set of variables including accelerator pedal position, engine speed, injected fuel quantity, gear position, turbo pressure where applicable, drive shaft speed and a state variable for auxiliary brakes which can include the air pressure in the auxiliary brakes and/or power supply to electrical retarders. The estimation of propulsion force and braking force from auxiliary brakes from said input data is carried out by conventional techniques well known to a person skilled in the art and will therefore not be explained in greater detail. The estimation of propulsion force from said given input data is described, for example, in Anderson B. D. O., More J. B., Optimal Filtering, Information and System Science Series. Prentice-Hall, University of Newcastle, New South Wales, Australia, 1979.

Output signals from the first function block constitute a first state variable s(1) corresponding to the propulsion force and a second state variable s(4) corresponding to the braking force from the auxiliary brakes.

These two state variables s(1) and s(4) form input data for a second function block 50 together with a third state variable s(3) corresponding to a binary value determining whether the service brakes are used or not, and a fourth state variable s(2) corresponding to the speed of the vehicle. In the second function block, the force in the vehicle's longitudinal direction is calculated. In a first embodiment of the invention, the force is calculated according to the following relationship:

f(t)=s(1)−0.5Cd*Area s2(s)−Cr*g*s(9)−s(4) where s(9) is a ninth state variable corresponding to an estimated value of the vehicle's mass. The force f(t) constitutes a fifth state variable s(5). In addition, a sixth state variable s(6) is created that constitutes the variance of the force f(t) and is used as a threshold value for estimation to be able to take place.

We have thus: f_threshold(t)=variance(f(t), s(5)=f(t) and s(6)=f_threshold(t).

In order to obtain a good estimation, it is necessary for the dynamic system to be stimulated sufficiently.

In an alternative embodiment of the invention, the calculation of the force from output signals from the first function block 40 is replaced by a calculation from an input signal from a third function block 60 where input signals from torque sensors are used instead of estimates based on other parameters.

Input signals to a fourth function block 70 consist of the output signals created in the second function block 50 and a seventh state variable s(7) corresponding to the estimated state vector Xest, an eighth state variable s(8) corresponding to the covariance matrix P(t) of the estimation error and, where applicable, updated values of the switching frequency ω_{c} and the interference intensity d. The state vector Xest comprises the states: speed, s(2), the gradient of the road s(10), the mass s(9) and the interference force. These states are given in the equation on top of page 10. In the fourth function block, a control is carried out in a first process step of whether the system is sufficiently stimulated for estimation to be allowed to take place. This is carried out by investigating whether the sixth state variable exceeds a particular limit value and whether the third state variable is equal to zero, which means that the service brakes are not being used. The condition has thus the following appearance: If s(3)=0 and s(6)>Threshold

If these conditions are fulfilled, the system matrix A(t) is defined in a second process step, which system matrix is a function of s(5), s(2), h, g, w_{c} and w_{d}, and the process interference matrix R₁(t) is defined, which process interference matrix is a function of s(2), d, and e. The system matrix is given by the equation given at the top of page 11. The appearance of the functions is given under the above description of Kalman filtering. In addition, a measurement matrix C(t) and measurement interference matrix R₂(t) are created, the appearance of which is also shown under the above description of Kalman filtering.

Thereafter in the third process step, the Ricatti equation, the Kalman filter, are calculated and the state vector is updated. During this process step, the estimate of the state vector Xest(t) forms a seventh state variable s(7) and the covariance matrix P(t) of the estimation error forms an eighth state variable s(8).

The optimal weighting matrix K(t+1) is calculated from the relationship:

K(t+1)=A(t)P(t)C^{T}(t)inv(C(t)P(t)C^{T}(t)+R₂(t))

The covariance matrix P(t) of the estimation error is calculated from the relationship:

P(t+1)=A(t)P(t)*A_{T}(t)−A(t)P(t)*C^{T}(t)inv(C(t)P(t)*C^{T}(t)+R₂(t))C(t)*P(t)*A^{T}(t)+R₁(t)

The estimate of the state vector Xest(t) is updated as follows:

Xest(t+1)=f(Xest(t),t)−K(t+1)(y(t)−C(t)_{Xest}(t))

If the condition for estimation was not fulfilled in the first process step, the covariance matrix and the state vector are replaced in a fourth step as follows:

P(t+1)=P(t);

Xest(t+1)=Xest(t)

For a fuller description of how the Ricatti equation and the Kalman filter are calculated, refer to Schmidtbauer B. “Modellbaserade reglersystem”, studentlitteratur 1999.

Output signals from the fourth function block 70 constitute the seventh state variable s(7) and the eighth state variable s(8). Where applicable, the state s(9) corresponding to an estimated value of the mass is selected from the seventh state variable s(7) in a fifth function block 80. Where applicable, a state s(10) corresponding to an estimated value of the gradient of the road on which the vehicle is being driven is selected in a sixth function block 90.

According to an embodiment of the invention, new estimated values of switching frequency and interference intensity of the variation of the gradient of the road are created in a seventh function block 100. These new values are input back to the fourth function block.

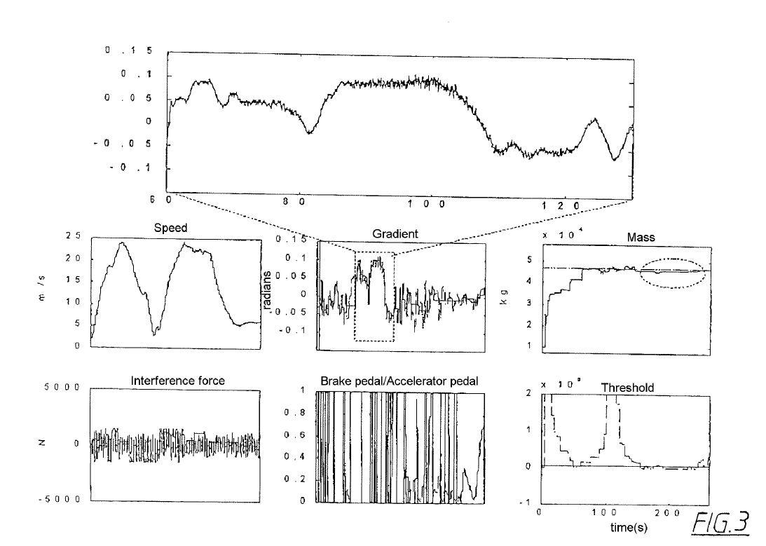

FIG. 3 shows the result from running a simulation model utilizing the estimating method described above. Broken lines represent actual parameter values and solid lines represent estimated values. In the shaded areas the system was stimulated too weakly, for which reason an error in the mass estimate would occur if no threshold requirement had been laid down. Note that the gradient of the road can be estimated even though the estimation of the mass is not running.

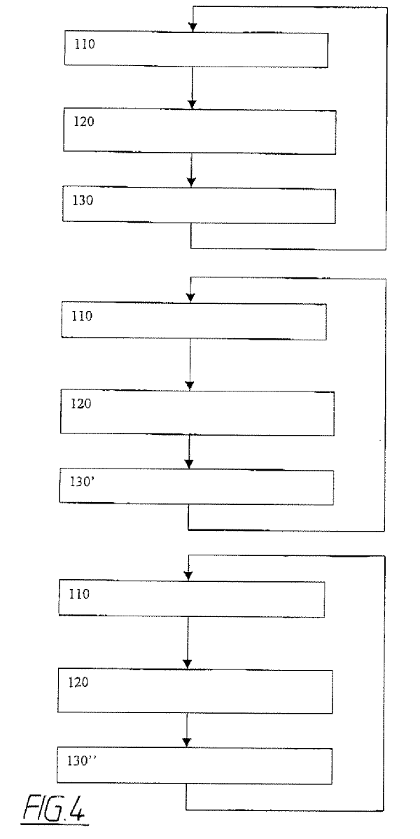

FIG. 4 shows schematically a method for estimating the mass of a vehicle according to the invention.

In a first method step 110, a measurement is carried out of the vehicle's speed for generating input data for a calculating device. The speed is measured in some way well known to a person skilled in the art, for example by a speedometer 19 (FIG. 1). The speed constitutes input data for a calculating device 34 (FIG. 1).

In a second method step 120, a measurement is carried out of a variable which comprises a longitudinal force acting on the vehicle for generating input data for a calculating device.

This measurement can be carried out according to a first embodiment via an accelerometer 35 (FIG. 1) which measures the vehicle's acceleration in a longitudinal direction and uses this information to determine a variable which comprises a longitudinal force acting on the vehicle.

According to an alternative embodiment, a variable is measured which comprises a longitudinal force acting on the vehicle by recording applied propulsion force fₚ and retardation forces fᵣ. For this purpose, the calculating device uses input signals from the brake control system 20 (FIG. 1) to determine the size of the applied braking forces, in particular the size of the force applied via the auxiliary brakes. In addition, the input signal from the speed sensor 19 (FIG. 1) is used to determine roll resistance and air resistance. In an embodiment of the invention, information is used from the engine control system 16 (FIG. 1) to determine torque delivered by the internal combustion engine. In another embodiment of the invention, the input signal is used from a torque sensor 36 (FIG. 1) placed along the vehicle's transmission line. In addition, the input signal from the gearbox control unit 21 (FIG. 1) is used for determining applied propulsion force from the calculated or measured propulsion torque.

Common to both embodiments is that the longitudinal force acting on the vehicle is determined.

According to a first embodiment of the invention, in a third method step 130 the calculating device 34 (FIG. 1) generates an estimate of the weight of the vehicle by a recursive process by using a statistical filter using said input data comprising the speed of the vehicle and said variable which comprises a longitudinal force acting on the vehicle and a statistical representation of a road with varying gradient.

The recursive process preferably consists of the recursive process that is described in association with FIG. 2. The recursive process consists preferably of a Kalman filter 70 (FIG. 2). The process uses the state variables: speed, gradient of the road, mass and interference force, according to the equations that are listed on top of page 10. According to an embodiment, the system matrix of the Kalman filter has the appearance that is defined at the bottom of page 10.

The statistical representation of a road with varying gradient is included in the system matrix. In an analysis, the frequency range of a reference road has been measured. Study of the frequency range shows that the frequency range can be approximated with relatively good accuracy by a first order process. Of course, other processes of higher order can be used, with the result that the dimensions of the state equations increase.

As the mass of the vehicle constitutes a state which is included in the recursive process, according to the first embodiment of the invention, the recursive process generates updated approximations of the mass.

According to a second embodiment of the invention, the recursive process generates updated approximations of the gradient of the road. This is carried out according to the second embodiment in a third method step 130″, which is identical to the third method step in the first embodiment, except that the state corresponding to the gradient of the road constitutes the state which is of interest. As the gradient of the road constitutes a state which is included in the recursive process, according to the second embodiment of the invention, the recursive process generates updated approximations of the gradient of the road.

According to a third embodiment of the invention, the recursive process generates updated approximations of the gradient of the road and the mass of the vehicle. This is carried out according to the third embodiment in a third method step 130″ which is identical to the third method step in the first or second embodiment, except that the states corresponding to the gradient of the road and the mass of the vehicle constitute the states that are of interest.

As the gradient of the road and the mass of the vehicle constitute states which are included in the recursive process, according to the third embodiment of the invention, the recursive process generates updated approximations of the gradient of the road and the mass.

The invention is not to be limited to the embodiments described above, but can be varied freely within the framework of the following patent claims, for example the invention can also be used in vehicles that are propelled by engines other than internal combustion engines, for example electric motors.

1. Method for estimating the mass of a vehicle which is being driven on a road with varying gradient, comprising the following method steps:
measurement of the vehicle's speed for generating input data for a calculation device;
measurement of a variable which comprises a longitudinal force acting on the vehicle for generating input data for a calculation device;
characterized in that
said calculation device generates an estimate of the weight of the vehicle by means of a recursive process by using a statistical filter using said input data comprising the speed of the vehicle and said variable and a statistical representation of a road with varying gradient.

2. Method according to claim 1, characterized in that said recursive process generates simultaneous estimates of the mass of the vehicle and the gradient of the road on which the vehicle is being driven.

3. Method according to claim 1, characterized in that said statistical filter consists of a Kalman filter or alternatively an extended Kalman filter representing the equation of motion of the vehicle.

4. Method according to claim 3, characterized in that the vehicle's speed and the gradient of the road are selected as state variables in said Kalman filter.

5. Method according to claim 1, characterized in that said statistical representation of the gradient of the road consists of a first order process with an intensity d and a switching frequency ω_{c}.

6. Method according to claim 5, characterized in that the size of said intensity d and the switching frequency are updated on the basis of information concerning the gradient of the road generated from said recursive process.

7. Method according to claim 1, characterized in that said parameter comprising a longitudinal force component is calculated from an estimate of torque delivered from an engine in said vehicle.

8. Method according to claim 7, where said engine consists of an internal combustion engine, characterized in that said delivered torque is estimated on the basis of information concerning the amount of fuel supplied to the combustion chamber of the internal combustion engine and the operating speed of the internal combustion engine.

9. Method according to claim 7, characterized in that said delivered torque is estimated from a torque sensor placed in association with the vehicle's transmission line.

10. Method according to claim 7, characterized in that said horizontal force component is calculated from said delivered torque and information concerning the current gearing between the drive shaft from the internal combustion engine and the vehicle's current driving wheels.

11. Method according to claim 1, characterized in that said parameter comprising a horizontal force component is estimated using an accelerometer which measures the acceleration in the longitudinal direction of the vehicle.

12. Method according to claim 1, characterized in that information regarding the mass of the vehicle is used for the apportionment of braking force between brakes in the vehicle's tractor unit and trailer.

13. Method for estimating the gradient of a road on which a vehicle is being driven, comprising the following method steps:
measurement of the vehicle's speed for generating input data for a calculation device;
measurement of a variable which comprises a longitudinal force acting on the vehicle for generating input data for a calculation device;
characterized in that
said calculation device generates by means of a recursive process an estimate of the gradient of the road on which the vehicle is being driven, by using a statistical filter using said input data comprising the vehicle's speed and said variable and a statistical representation of a road with varying gradient.

14. Method according to claim 13, characterized in that said statistical filter consists of a Kalman filter or alternatively an extended Kalman filter representing the equation of motion of the vehicle.

15. Method according to claim 14, characterized in that the vehicle's speed and the gradient of the road are selected as state variables in said Kalman filter.

16. Method according to claim 13, characterized in that said statistical representation of the gradient of the road consists of a first order process with an intensity d and a switching frequency ω_{c}.

17. Method according to claim 16, characterized in that the size of said intensity d and the switching frequency ω_{c} are updated on the basis of information concerning the gradient of the road generated from said recursive process.

18. Method according to claim 13, characterized in that said parameter comprising a longitudinal force component is calculated from an estimate of torque delivered from an engine in said vehicle.

19. Method according to claim 18, where said engine consists of an internal combustion engine, characterized in that said delivered torque is estimated on the basis of information concerning the amount of fuel supplied to the combustion chamber of the internal combustion engine and the operating speed of the internal combustion engine.

20. Method according to claim 18, characterized in that said delivered torque is estimated from a torque sensor placed in association with the vehicle's transmission line.

21. Method according to claim 18, characterized in that said horizontal force component is calculated from said delivered torque and information concerning the current gearing between the drive shaft from the internal combustion engine and the vehicle's current driving wheels.

22. Method according to claim 13, characterized in that said parameter comprising a horizontal force component is estimated using an accelerometer which measures the acceleration in the longitudinal direction of the vehicle.

23. Method according to claim 13, characterized in that information regarding the mass of the vehicle is used for the apportionment of braking force between brakes in the vehicle's tractor unit and trailer.
